(19) United States
(12) Patent Application Publication
(10) Pub. No.: US 2026/0084939 A1
(43) Pub. Date: Mar. 26, 2026

(54) BATTERY POWERED HOIST SYSTEMS AND METHODS

(71) Applicant: SafeWorks, LLC, Atlanta, GA (US)

(72) Inventors: Stephen James AVERY, Seattle, WA (US); Samuel HANSON, Port Orchard, WA (US); Ronald PAREDES, Lake Stevens, WA (US); Morgan Lee KNICKREHM, Whitefish, MT (US)

(73) Assignee: SafeWorks, LLC, Atlanta, GA (US)

(21) Appl. No.: 19/321,694

(22) Filed: Sep. 8, 2025

Related U.S. Application Data
(60) Provisional application No. 63/697,097, filed on Sep. 20, 2024.

(51) Int. Cl. B66D 1/48; B66D 1/60; H02J 7/00

(52) U.S. Cl. CPC B66D 1/485; B66D 1/60; H02J 7/82; H02J 7/855; H02J 7/963; H02J 7/977; B66D 2700/025

(57) ABSTRACT

Systems, methods, and apparatuses related to hoist systems are provided herein. The system includes a battery and a hoist. The hoist includes a motor configured to move the hoist relative to a cable and to provide power generated by moving the hoist to the battery and a controller. The controller is configured to receive data indicative of a load on the hoist and to operate the motor to stop movement of the hoist relative to the cable based on the load on the hoist exceeding a predefined threshold.

### CROSS-REFERENCE TO RELATED PATENT APPLICATIONS

This application claims the benefit of and priority to U.S. Provisional Application No. 63/697,097, filed Sep. 20, 2024, which is incorporated herein by reference in its entirety and for all purposes.

### BACKGROUND

The present disclosure relates generally to the field of lifting systems. Hoists are used to facilitate vertical movement for lifting and lowering loads in various applications. Swing stages, which are temporary platforms suspended from a building's structure, are frequently used for tasks like window cleaning, painting, and facade maintenance. These platforms use hoists to move the platform along a building. Mast climbers are vertical platforms that ascend and descend along a mast or tower, supporting construction and maintenance work at elevated heights. The hoists in mast climbers control movement along the mast.

### SUMMARY

One embodiment relates to a system. The system includes a battery and a hoist. The hoist includes a motor configured to move the hoist relative to a cable and to provide power generated by moving the hoist to the battery and a controller. The controller is configured to receive data indicative of a load on the hoist and to operate the motor to stop movement of the hoist relative to the cable based on the load on the hoist exceeding a predefined threshold.

Another embodiment relates to a system. The system includes a hoist, an accelerometer configured to measure movement of the hoist, and a controller. The controller is configured to receive data indicative of movement of the hoist from the accelerometer and to receive data indicative of one or more directional input commands associated with the hoist. The controller is configured to correlate the movement of the hoist with the one or more directional input commands having an expected motion condition associated with the hoist. The controller is configured to operate an indicator device based on the movement of the hoist failing to meet the expected motion condition associated with the hoist.

Another embodiment relates to a hoist. The hoist includes an accelerometer configured to measure movement of the hoist and an indicator device configured to indicate one or more operating conditions of the hoist. The one or more operating conditions include a stall condition. The hoist includes a controller. The controller is configured to receive data indicative of movement of the hoist from the accelerometer and to receive data indicative of one or more directional input commands associated with the hoist. The controller is configured to correlate the movement of the hoist with the one or more directional input commands having an expected motion condition associated with the hoist. The hoist failing to meet the expected motion condition associated with the hoist corresponds to the stall condition. The controller is configured to operate the indicator device based on the stall condition.

This summary is illustrative only and is not intended to be in any way limiting. Other aspects, inventive features, and advantages of the devices or processes described herein will become apparent based on the detailed description set forth herein, taken in conjunction with the accompanying drawings.

### BRIEF DESCRIPTION OF THE DRAWINGS

The accompanying drawings are not intended to be drawn to scale. Like reference numbers and designations in the various drawings indicate like elements. For purposes of clarity, not every component may be labeled in every drawing.

FIG. 1 is a perspective view of a swing stage including a lift system, according to an exemplary embodiment.

FIG. 2 is a front view of a mast climber including a lift system, according to an exemplary embodiment.

FIG. 3 is a front view of a wind turbine including a lift system, according to an exemplary embodiment.

FIG. 4 is a front view of a wind turbine including a wireless charging pad to charge components of the lift system, according to an exemplary embodiment.

FIG. 5 is a perspective view of a hoist and a power supply battery, according to an exemplary embodiment.

FIG. 6A is an internal side view of mechanical elements of the hoist of FIG. 5, according to an exemplary embodiment.

FIG. 6B is another internal side view of mechanical elements of the hoist of FIG. 5, according to an exemplary embodiment.

FIG. 7 is a block diagram of a control system of the hoist of FIG. 5, according to exemplary embodiments.

FIG. 8 is a block diagram of a control system of the hoist of FIG. 5, according to exemplary embodiments.

FIG. 9 is a flow diagram of a process for determining a load on the hoist of FIG. 5 based on voltage drop across a battery, according to exemplary embodiments.

FIG. 10 is a graphical diagram of the process of FIG. 9, according to exemplary embodiments.

FIG. 11 is a flow diagram of a process for operating an indicator device based on data from an accelerometer and direction inputs from directional controls associated with the hoist of FIG. 5, according to exemplary embodiments.

FIG. 12 is a graphical diagram of the process of FIG. 11, according to exemplary embodiments.

FIG. 13 is a flow diagram of a process for operating an indicator device based on data from an accelerometer, direction inputs from directional controls, and an estimated load associated with the hoist of FIG. 5, according to exemplary embodiments.

### DETAILED DESCRIPTION

Following below are more detailed descriptions of various concepts related to, and implementations of methods, apparatuses, and systems related to the embodiments introduced above. The illustrative embodiments described herein are not meant to be limiting. Other embodiments may be utilized, and other changes may be made, without departing from the spirit or scope of the subject matter presented herein. It will be readily understood that the aspects of the present disclosure, as generally described herein, and illustrated in the figures, can be arranged, substituted, combined, and designed in a wide variety of different configurations, all of which are explicitly contemplated and made part of this disclosure.

Referring generally to the figures, a hoist is shown, according to various embodiments. The hoist includes a motor and a power source, such as a battery. The hoist is configured to raise and lower loads along a rope or cable. The hoist includes overspeed and overload protection mechanisms. In some examples, the overspeed and overload protections are provided by a controller. The controller may moderate the speed of the hoist by receiving data associated with the descent or ascent speed of the hoist and determining whether the speed meets or exceeds a threshold. If the speed meets or exceeds a threshold, the controller may cause the motor to apply brakes to slow the speed of the hoist. Additionally or alternatively, the controller causes a variable frequency drive (VFD) to change the frequency of electrical power supplied to the motor. In such an example, the VFD may decrease the frequency of electrical power supplied to the motor to slow the hoist. The controller may moderate the load of the hoist using weight data and/or by metering the power routed from the battery to the hoist. In such examples, the controller receives data associated with the weight of the load from a load cell and determines whether the load exceeds a threshold. If the load exceeds a threshold, the controller may inhibit movement of the hoist (e.g., by applying brakes, by not supplying power to the motor, etc.).

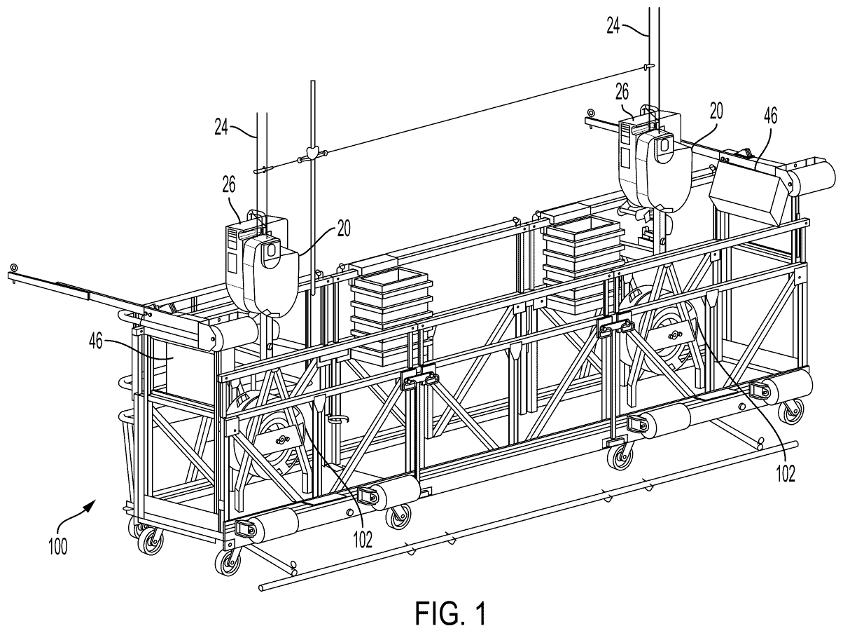

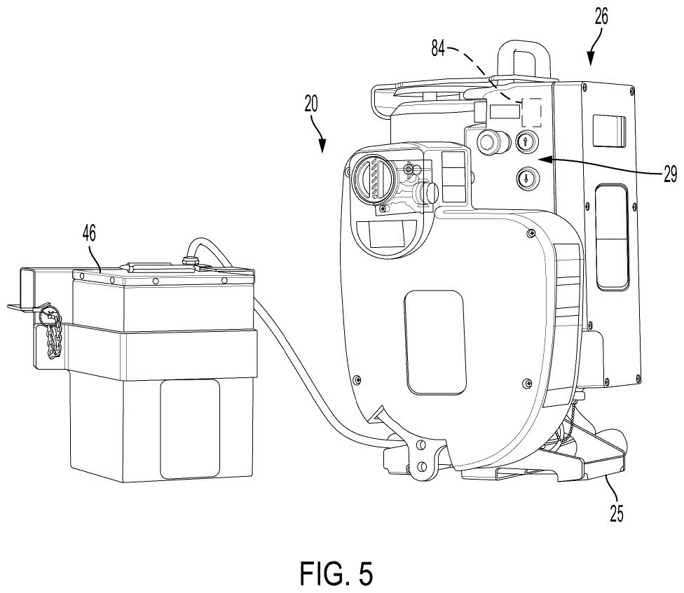

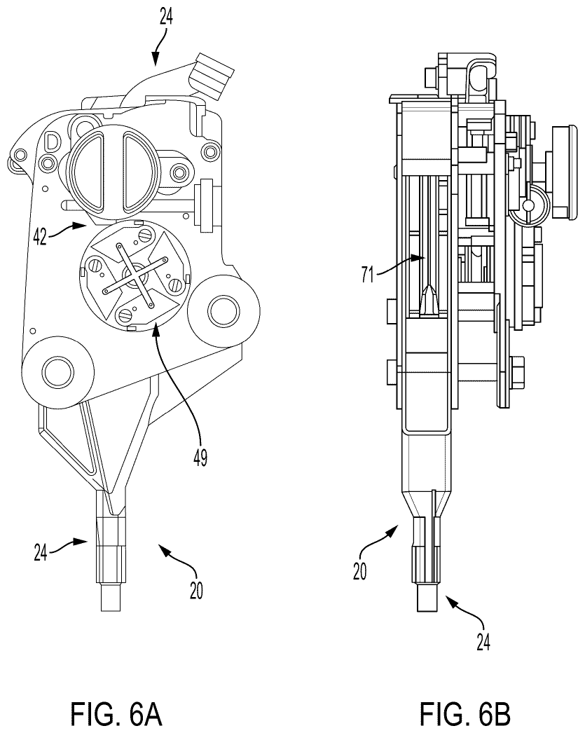

Referring to FIG. 1, a perspective view of a swing stage 100 having a lift system is shown, according to an exemplary embodiment. The swing stage 100 is shown to include a platform and a set of handrails. The swing stage 100 is configured to be anchored to a building. The swing stage 100 supports work crews maneuvering about the exterior of the building. In operation, the swing stage 100 translates vertically about the cables 24 using one or more hoists 20. The swing stage 100 is shown to include two hoists 20 that are configured to lift and lower the swing stage 100 relative to the cables 24. Each hoist 20 is attached to a cable 24 by feeding the cable 24 through a wire rope insertion point in the top of the hoist 20. In exemplary embodiments, the hoists 20 are traction type hoists that utilize a motor (e.g., the motor 26 shown in FIG. 5) operatively coupled with a traction sheave (i.e., traction sheave 71 shown in FIGS. 6A and 6B) to move the hoist 20 vertically along the cables 24. The hoist 20 may further include an overspeed safety mechanism, which is configured to slow or stop the swing stage 100 from lowering when the swing stage 100 reaches a predetermined descent speed. The batteries 46 provide a source of direct current (DC) power to the hoists 20. As shown in FIG. 1, the batteries 46 are typically placed on and/or attached to the platform or railing of the swing stage 100 and are coupled to the hoist 20 by way of a power supply cable. In exemplary embodiments, the power supply cable runs from the batteries 46 to the hoists 20 through or on the railing of the swing stage 100.

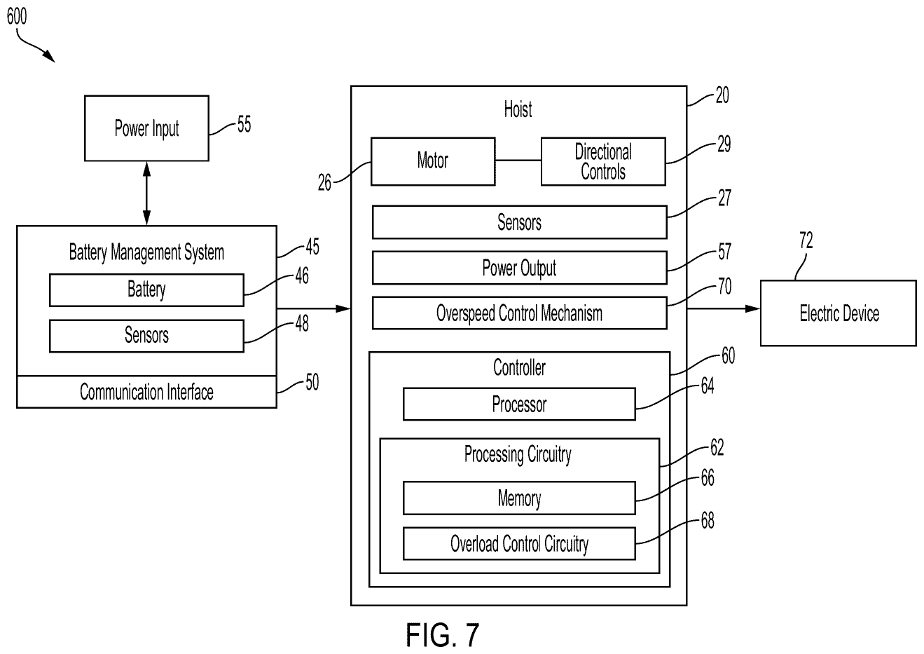

The swing stage 100 is shown to include a wire winder 102 for each hoist 20. The wire winders 102 are designed to rotate as the swing stage 100 moves about the cables 24 and wrap each cable 24 exiting through a bottom portion of the traction hoists 20. In some embodiments, the wire winders 102 may be used to wind up cables other than the cables 24, for example, electrical cables, hoses, tubing, and the like. In some examples, the batteries 46 power the wire winders 102. In some examples, the hoists 20 include a power output (e.g., the power output 57 of FIG. 7) that is used to power the wire winders 102. It will be appreciated that the batteries 46 can be any type of battery providing any voltage level. In other examples, the wire winders 102 are mechanically/manually (e.g., unpowered) operated to wind up cables, ropes, or wires.

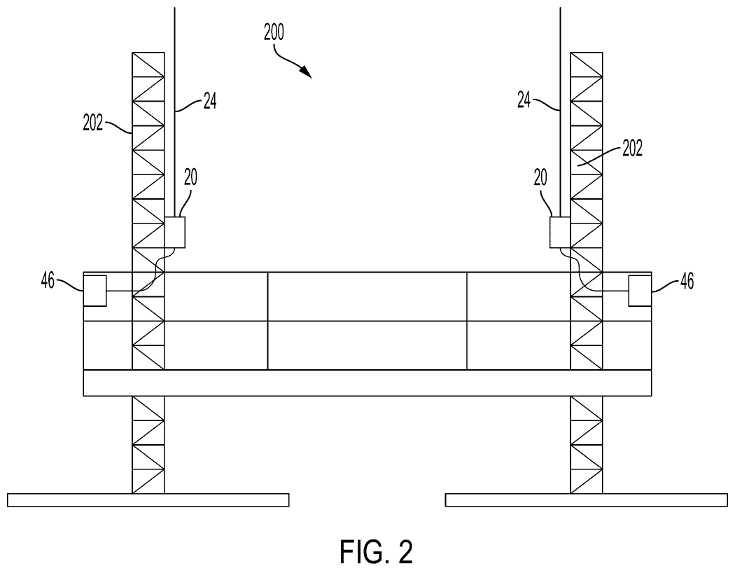

Referring to FIG. 2, a front view of a mast climber 200 having a lift system is shown, according to exemplary embodiments. The mast climber 200 is shown to include a platform and set of handrails, the mast climber 200 configured to move vertically along one or more masts 202. The masts 202 are fixed vertical structures that may be anchored to a building or frame. The masts 202 act as vertical guides for the mast climber 200. The mast climber 200 is shown to include two hoists 20, which serve to lift and lower the mast climber 200 vertically along the cables 24. One or more batteries 46 power the hoists 20. In some embodiments, two or more batteries 46 are wired together to power one hoist 20 of the mast climber 200. In some embodiments, the motors 26 of the hoists 20 may be larger or more powerful in mast climber 200 applications than in other applications (e.g., the swing stage 100 of FIG. 1).

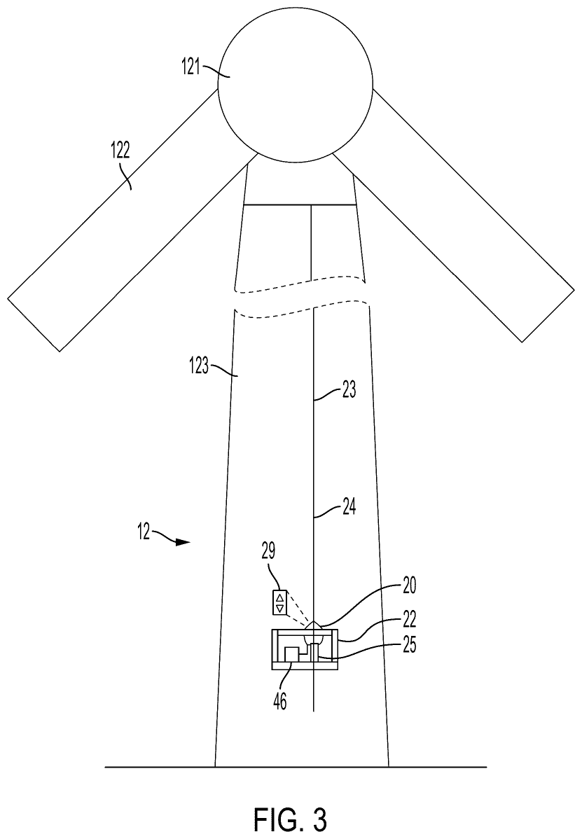

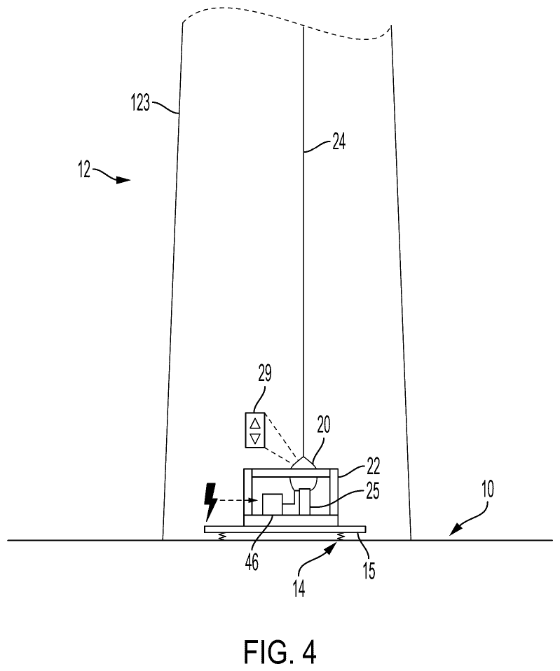

Referring to FIGS. 3 and 4, front views of a wind turbine 12 including a lift system is shown, according to an exemplary embodiment. The wind turbine 12 is shown to include turbine blades 122 coupled to a hub 121. The hub 121 is coupled with a portion of a tower 123. The interior of the tower 123 includes an elevator car 22 that moves vertically along the cables 24 between stations or stops. The hoist 20 is configured to lift and lower an elevator car 22 inside of the tower 123 of a wind turbine 12. In exemplary embodiments, the hoist 20 is a traction type hoist. In some examples, the hoist 20 is attached by stirrup bar 25 to a corresponding stirrup on the elevator car 22.

The hoist 20 may further include a control mechanism, shown as directional controls 29, that is configured to receive an input from a user and control the hoist 20 based on the input. In some embodiments, the directional controls 29 may be a part of or coupled with the elevator car 22 (e.g., built into or electrically coupled with the hoist 20) and accessible to a person standing on the platform to enable the person to control the hoist 20 to control movement of the elevator car 22. The directional controls 29 are configured to send a signal to the hoist 20 to move the elevator car 22 in a direction that corresponds to the input from the user. For example, the directional controls 29 may include a plurality of buttons, including a first button configured to send a signal to a hoist motor (e.g., the motor 26 shown in FIG. 5) to raise the load, a second button configured to send a signal to the hoist motor to lower the load, and a third button configured to send a signal to the motor to stop movement of the load. The directional controls 29 may be associated with one or more responsive expected motion conditions of the hoist 20. For example, responsive to an operator pushing the first button, the responsive expected motion condition of the hoist 20 may be or include upward acceleration or velocity of the hoist 20 as it moves along the cable 24.

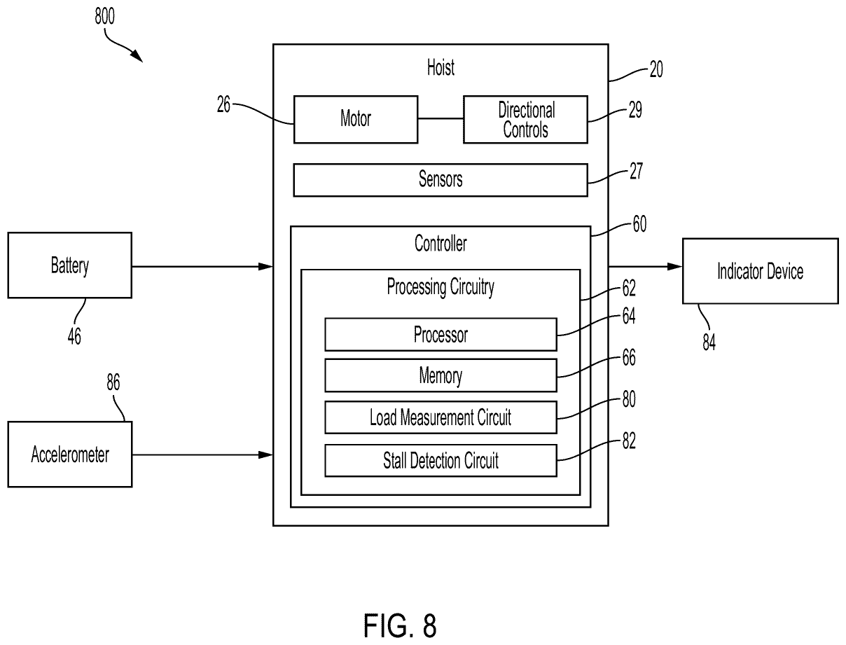

The hoist 20 is shown to include an indicator device 84. The indicator device 84 may be or include one or more lights (e.g., light emitting diodes, etc.). For example, the indicator device 84 may be or include one light that is generally off (e.g., unlit) while the hoist 20 operates according to predefined normal conditions and is turned on (e.g., lit) to indicate a predefined condition, such as a stall condition or a fault. The indicator device may include a plurality of lights that correspond to a plurality of predefined conditions (e.g., normal conditions, stall conditions, a predefined fault, etc.). The indicator device 84 may be or include an alarm (e.g., an audial alarm, vibrations, flashes, etc.). As will be described in greater detail below with respect to FIG. 8, a controller (e.g., controller 60) may operate the indicator device 84 to indicate one or more hoist 20 conditions based on operating data.

A portable battery 46 is coupled to the hoist 20 during operation of the elevator car 22. The battery 46 provides a source of direct current (DC) power to the hoist 20. The battery 46 is typically placed on and/or attached to the platform of elevator car 22 and is coupled to the hoist 20 by way of a power supply cable. The battery 46 may be installed on the platform of elevator car 22, for example on rails on a bottom side of the platform of elevator car 22, or on vertical rails of the elevator car 22. The battery 46 may be removed from the elevator car 22 and recharged without requiring the hoist 20 to be disconnected from the platform and/or cable 24. In this way, the battery 46 can be removed from hoist 20 and used to operate another hoist in another wind tower or used to power other devices. In some examples, the battery 46 remains coupled with the elevator car 22 while the elevator car 22 is not in use. In such examples, the battery 46 is charged by a power input coupled with the interior of the wind turbine 12 (e.g., a power outlet, a wireless charging platform, etc.). In some embodiments, the battery 46 may include a secondary battery that provides power to the hoist 20 to move the hoist 20 to a location, e.g., along the length of the cable 24 to access power to recharge either one or both batteries of the battery 46. The battery 46 may be installed in one location on the platform, or in multiple locations.

In some embodiments, the battery 46 may be wirelessly charged on a charging pad, such as the charging pad 15 of FIG. 4. In such examples, a charging pad 15 may be installed on a floor or a platform of an elevator shaft or proximate a tower 123. In exemplary embodiments, the charging pad 15 includes springs 14 that couple with charging terminals of the battery 46. In such examples, one spring 14 is a positive spring and the other spring 14 is a negative spring. Compression of the springs 14 by the battery 46 may trigger a mechanical action (e.g., actuating a switch, a lever, or a button on a control panel). By way of example, the springs 14 actuate a switch to turn on the power source. In some examples, the power supply may include one or more sensors that sense contact with the battery 46 or compression of the springs 14. Upon sensed contact with the battery 46 or compression of the springs 14, the power supply begins supplying power to the battery. By way of example, the springs 14 actuate a switch to turn on a power source to the charging pad 15. In some embodiments, the battery 46 is part of a battery management system (BMS) (e.g., the BMS 45 of FIG. 7) which may be communicatively coupled to a control panel that moderates the power source of the charging pad 15. The BMS may transmit state of charge information regarding the battery 46 to the control panel. In exemplary embodiments, the control panel turns off the power source and/or stops transmitting power from the power source to the charging pad 15 upon the SOC of the battery 46 reaching a threshold (e.g., 90%, 95%, 100%).

The charging pad 15 may be configured to charge the battery 46 using electromagnetic induction. The charging pad 15 includes a first (i.e., “primary”) coil connected to an AC power source (e.g., an outlet or port in the interior of the tower 123) and a secondary coil that connects to the battery 46. The alternating current creates a magnetic field in the primary coil, which induces an electrical current in the second coil. The electrical current induced in the second coil is transferred to the battery 46 through close contact or direct contact. In some embodiments, the primary coil is configured to resonate at the same frequency as a coil inside or connected to the battery 46. In this way, the charging pad 15 may resonantly charging the battery 46. Advantageously, resonant charging enables the charging pad 15 to charge the battery 46 with close contact rather than requiring direct contact or a specific alignment with the charging pad 15. In exemplary embodiments, the charging pad 15 is activated by a spring mechanism. The springs 14 trigger a mechanical action (e.g., actuating a switch, a lever, or a button on a control panel) when moved from a neutral position to a compressed position. By way of example, the springs 14 actuate a switch to turn on the power source connected to the primary coil. In this way, the elevator car 22 compresses the springs 14 when resting on the charging pad 15. Such compression powers the primary coil, which in turn, enables wireless charging of the battery 46.

Referring to FIGS. 5-6B, various views of the hoist 20 and its components are shown, according to exemplary embodiments. The hoist 20 is shown to include a motor 26, directional controls 29, and a stirrup bar 25. The hoist 20 is coupled with a battery 46 via an electrical cable.

The battery 46 provides a source of direct current (DC) power to hoist 20. The battery 46 may be a lithium-based chemistry such as lithium ion, lithium phosphate, nickel manganese cobalt, or other suitable chemistry. In exemplary embodiments, the battery 46 is a 48V battery. However, it will be appreciated that the battery 46 can be any type of battery providing any voltage level. In some examples, the motor 26 is a direct current motor that is configured to receive the battery 46 power as an input and convert the power into movement. The motor 26 may be sized in a range between 1 kW and 15 kW. In some examples, additional secondary batteries may be wired in series or in parallel with the battery 46. In this way, battery power may be added to or removed from the hoisting system depending on the size and voltage of the motor 26.

The hoist 20, and in particular, the motor 26, can engage in regenerative braking. Regenerative braking converts kinetic energy produced by the hoist 20 during descent into electrical energy. During ascent, the motor 26 rotates in a first direction to provide the rotational force used to lift and lower a load (e.g., the swing stage 100, the mast climber 200, the elevator car 22, etc.). During descent, the motor 26 acts as a generator by rotating in a second direction to convert kinetic energy into electrical energy. When the hoist 20 is lowering a load, or is decelerating, the motor 26 captures the kinetic energy generated by the load's descent and converts the kinetic energy into electrical energy. The electrical energy is generally directed to the battery 46. However, the electrical energy may be redirected to a resistor or a capacitor (e.g., the electric device 72 shown in FIG. 7), auxiliary systems (e.g., lighting, control electronics, communications devices, etc.), a larger power grid (e.g., a building generator), or anything of the like.

As shown in FIGS. 6A and 6B, the cable 24 is routed through the hoist 20 such that the cable 24 is inserted in a top side and exits through a bottom side of the hoist 20. A traction sheave 71 is rotated by the motor 26 to raise or lower the hoist 20 relative to the cable 24. The traction sheave 71 pulls on the cable 24 to move upwards and releases the cable 24 to move downwards. A flywheel 49 works in conjunction with an overspeed system to monitor the speed of descent of the hoist 20. In some examples, the hoist 20 includes one or more sensors, shown as sensors 27 in FIG. 7, configured to collect data associated with the speed of descent of the hoist 20. The sensors 27 may be one or more real or virtual sensors disposed anywhere in the system 600. An overspeed device 42 is coupled with an overspeed brake and an overspeed sensing device (e.g., a speed sensor/switch, a rotary sensor, etc.). Upon the speed of the hoist 20 exceeding a predetermined threshold, the overspeed device 42 engages the overspeed brake to slow or stop the hoist 20. For example, the overspeed device 42 may engage a cam that pinches the cable 24 against an internal guide to forcibly slow or stop the hoist 20.

Referring to FIG. 7, a block diagram of a system 600 including the hoist 20 is shown, according to exemplary embodiments. The system 600 is shown to include a power input 55, a battery management system (BMS) 45, the hoist 20, and an electric device 72. As discussed above, the hoist 20 includes a motor 26 and directional controls 29. The hoist 20 may further include one or more sensors 27, one or more power outputs/power pass throughs 57, and a controller 60.

In some examples, the electric device 72 is a resistor configured to dissipate excess energy generated by the motor 26 when performing regenerative braking. The electric device 72 may include one or more wire-wound resistors, metal oxide resistors, ceramic resistors, or a combination thereof. In other examples, the electric device 72 is a capacitor configured to dissipate the energy generated by the motor 26 when performing regenerative braking. The electric device 72 may include electrolytic capacitors, ceramic capacitors, mica capacitors, variable capacitors, or any combination thereof. By way of example, the controller 60 may route power generated by the motor 26 to the electric device 72 when the battery 46 is at 100% state of charge (SOC). In this way the electric device 72 prevents overcharging of the battery 46 in regenerative braking applications.

The hoist 20 may include any number, placement, or type of sensors 27. The sensors 27 may be real or virtual. In exemplary embodiments, the sensors 27 collect data associated with the descent speed of the hoist 20. The sensors 27 may, for example, include a hall effect sensor that measures the speed of rotation of the motor 26. The sensors 27 may include other types of speed sensors, torque sensors, weight sensors, load sensors, and the like. The sensors 27 are configured to send a data to the controller 60 associated with the speed of ascent and/or descent of the hoist 20 and the weight/load on the hoist 20.

The power output 57 may be a power pass through device or a power output port. The power output 57 is powered by the battery 46. In exemplary embodiments, the power output 57 is a 48V pass through device having a port for users to connect battery powered accessories for purposes of powering or charging the accessories (e.g., power tools such as drills, sanders, saws, impact drivers, and the like). In this example, the 48V pass through device may be used to power a wire winder (e.g., the wire winder 102 of FIG. 1) that winds the cables 24 neatly onto a spool. Additionally or alternatively, the power output 57 can include a converter (e.g., a buck converter) that converts a 48V input voltage from the battery 46 to a lower output voltage. For example, the power output 57 may be a 12V pass through device having a port for users to connect smaller battery powered accessories for purposes of powering or charging the accessories (e.g., a phone, tablet, laptop, lighting, radios, portable fans, etc.).

The controller 60 can include processing circuitry 62, having one or more processors 64, one or more memory devices 66, and one or more specialized processing circuits, shown as overload control circuitry 68. The memory 66 is one or more devices (e.g., RAM, ROM, Flash memory, hard disk storage) for storing data and/or computer code for completing and/or facilitating the various processes described herein. The memory 66 includes one or more of non-transient volatile memory, non-volatile memory, or non-transitory computer storage media. The memory 66 includes database components, object code components, script components, or any other type of information structure for supporting the various activities and information structures described herein. The memory 66 is communicatively coupled to the processor 64 and includes computer code or instructions for executing one or more processes described herein. The processor 64 can be implemented as one or more application specific integrated circuits (ASICs), field programmable gate arrays (FPGAs), a basic controller, programmable logic controllers (PLCs), a group of processing components, or other suitable electronic processing components. Accordingly, in some embodiments, the controller 60 does not include the processor 64 or the memory 66.

The overspeed control mechanism 70 is configured to control the speed of the hoist 20. In some embodiments, the overspeed control mechanism 70 is a mechanical mechanism that uses spinning weights or flyweights mounted on a shaft (e.g., the flywheel 49 of FIG. 6A). If the weights move beyond a predefined point due to excessive speed, the overspeed control mechanism may engage the brakes or other stopping mechanisms directly or using a mechanical linkage.

In other examples, the overspeed control mechanism 70 is a specialized circuit disposed on the controller 60. In such examples, the overspeed control mechanism 70 sends control signals to the motor 26 to control the output of the motor 26. The control signals may control, for example the speed, direction, and torque of the motor 26. Responsive to receiving sensor data from the sensors 27 indicating that the hoist 20 is traveling above a predefined threshold descent speed, the controller 60 may transmit a signal to the motor 26 to slow the speed of descent. The motor 26 may include a variable frequency drive (VFD) that changes the frequency of electrical power supplied to the motor. By way of example, responsive to the controller 60 transmitting a signal to the motor 26, the VFD may decrease the frequency of electrical power supplied to the motor 26 to slow the hoist 20. The motor 26, upon receiving the corresponding signal from the controller 60, may apply traction or brakes (e.g., to the traction sheave 71). In some embodiments, the sensors 27 provide feedback to the controller 60 in regular intervals (e.g., every 10 seconds, every 30 seconds, every minute, etc.), which allows the overspeed control mechanism 70 to maintain the speed of descent below a threshold as the hoist 20 moves relative to the cable 24.

The overload control circuitry 68 is configured to limit lifting by the hoist 20 based on load. In one example, the overload control circuitry 68 receives sensor data from a load cell associated with the weight of the load on the hoist 20. In exemplary embodiments, the controller 60 receives data associated with the weight of the load on the hoist 20 from the load cell. Responsive to the weight exceeding a load weight threshold, the controller 60 stops lifting hoist 20. In some examples, the controller 60 stops supplying power from the battery 46 to the motor 26 to stop lifting the hoist 20. Alternatively or additionally, the controller 60 applies mechanical brakes in the motor 26. Alternatively or additionally, the controller 60 stops supplying power from the battery 46 to the directional controls 29 such that user inputs on the directional controls 29 are rendered moot. A user (e.g., the hoist provider, hoist owner, etc.) may set the load threshold in units of load weight (e.g., kilograms, pounds, etc.). In some examples, the controller 60 is set to stop/prevent lifting procedures responsive to a measured load exceeding 125% of the rated load of the motor 26. By way of example, the motor 26 may be rated for 1000 lbs. In this example, the controller 60 causes the motor 26 to stall responsive to receiving a load weight of 1250 lbs or more from a weight sensor. In some embodiments, the preset load threshold is three times the rated load of the motor 26. In other examples, the preset threshold is a value or formula set by a regulatory authority.

As discussed above, the controller 60 is configured to receive a DC power input from the battery 46 and modulate/meter the feed of power that is supplied to the motor 26. In exemplary embodiments, the controller 60 limits the current supplied from the battery 46 to the motor 26 based on a preset load threshold. By way of example, the controller 60 may receive a 1000 lb limit for a hoist 20 having a motor 26 rated for 2000 lbs. In this example, the controller 60 may output 50 amps of current to the motor 26 to maintain a 1000 lb load limit, despite the motor 26 being capable of moving larger loads. In this way, the controller 60 acts as an overload mechanism by metering the current to the motor 26. Advantageously, the hoist 20 may serve multiple sizes of loads without needing to change the size of the motor 26 to match the load. Stated a different way, one 2000 lb load limited motor 26 may be used, for example, in applications hoisting 1000 lbs or 1500 lbs with the controller 60 metering the power supplied to the motor 26 based on the load size (e.g., 50 amps for 1000 lb loads, 75 amps for 1500 lb loads, and 100 amps for 2000 lb loads).

The controller 60 may be programmed to impose upper limits on the hoist 20. For example, the controller 60 may include a specialized circuit programmed to change the capacity of the hoist 20 depending on a user request or situation. In some examples, the overload control circuitry 68 is configured to impose various upper limits on the operation of the hoist 20. The controller 60 may be communicatively coupled with a device, such as a remote computing system, a cloud computing system, a point-of-sale device, an integrated sensor or external sensor, an integrated or external circuit, or the like (i.e., “the device”). In some embodiments, the device may be a remote computing system that receives user input regarding rules/operational limits for a hoist 20. The user inputs may then be transmitted to the controller 60, specialized circuitry on the controller 60, or the overload control circuitry 68. The controller 60 may then limit operation of the hoist 20 based on the rules and operational limits transmitted from the device. In some embodiments, the device may be a sensor, or a circuit integrated into the hoist 20 that is not critical to operation of the hoist 20 but is configured to communicate with the controller 60.

In some examples, the hoist 20 includes a radio frequency identification device (RFID) tag. The RFID tag contains data regarding rules and/or operational limits for the given hoist 20 (i.e., “hoist operating rules”). For example, the RFID tag may include speed limits or load limits. Such limits may be preset or predetermined based on application. For example, a hoist 20 inside an elevator shaft (e.g., as shown in FIGS. 3 and 4) can be enabled to move twice as fast as a hoist 20 disposed outside of a building (e.g., as shown in FIGS. 1 and 2). As another example, a user may require a hoist 20 with a 1000 lb load limit when a provider only has 1500 lb load limit hoists 20 available. In this example, an upper load limit of 1000 lbs is set such that the 1500 lb load limit hoist 20 is configured to impose 1000 lb load limit rules.

In exemplary embodiments, an RFID reader transmits hoist operating rules stored on the RFID tag to the controller 60. The controller 60 may store the hoist operating rules on the memory 66. The overload control circuitry 68 and the overspeed control mechanism 70 may access and apply the hoist operating rules stored on the memory 66. By way of example, a hoist operating rule may be a maximum load threshold of 1500 lbs. The overload control circuitry 68 may limit operation of the hoist 20 responsive to receiving an indication that the load exceeds the 1500 lb threshold. The overload control circuitry 68 may, for example, stop transmitting power from the battery 46 to the motor 26. Additionally or alternatively, the overload control circuitry 68 may cause the hoist 20 to apply brakes to the traction sheave 71 such that the traction sheave 71 is prevented from rotating. As another example, a hoist operating rule may be a maximum speed of 35 feet per minute. The overspeed control mechanism 70 may limit operation of the hoist 20 responsive to receiving an indication that the speed exceeds 35 feet per minute. For example, the overspeed control mechanism 70 may cause the hoist 20 to apply brakes to the traction sheave 71 to slow the speed to descent or ascent.

As shown in FIG. 7, the battery 46 that powers the hoist 20 includes a battery management system 45. The battery management system 45 includes one or more sensors 48. In some examples, the sensors 48 can monitor, receive, and/or acquire data indicative of the state of charge (SOC) of the battery 46. In an exemplary embodiment, one or more sensors 48 include one or more temperature sensors that are disposed on the battery or proximate to the battery to measure battery temperature. The battery temperature measurements and the state of charge measurements are transmitted to the battery management system 45, according to exemplary embodiments. The battery management system 45 is communicatively coupled with the controller 60 and the power input 55 via the communication interface 50.

The communication interface 50 may be configured to communicate with hoist 20 or another external device using any type and number of wired and wireless protocols (e.g., any standard under IEEE 802, etc.). For example, a wired connection may include a serial cable, a fiber optic cable, an SAE J1939 bus, a CAT5 cable, or any other form of wired connection. In comparison, a wireless connection may include the Internet, Wi-Fi, Bluetooth, ZigBee, cellular, radio, etc. In one embodiment, a controller area network (CAN) bus including any number of wired and wireless connections provides the exchange of signals, information, and/or data between the controller 60 and the communication interface 50. In still another embodiment, the communication between the battery management system 45 and the controller 60 is via the unified diagnostic services (UDS) protocol.

The battery management system 45 is configured to transmit battery data (e.g., SOC, battery temperature, etc.) to the power input 55. In exemplary embodiments, the power input 55 charges the battery 46 by wired or wireless connections. The power input 55 may include internal programming and/or logic regarding charging speed scheme for the battery 46. In exemplary embodiments, the battery management system 45 is configured to transmit the SOC of the battery 46 to the power input 55. The power input 55 may, in turn, determine a charging scheme for the battery 46 based on the SOC of the battery 46. In some embodiments, the power input 55 stops charging the battery 46 once the battery 46 reaches a SOC threshold. For example, the power input 55 may stop charging the battery 46 once the battery 46 reaches a 90% or 95% SOC. Advantageously, the hoist 20 powered by the battery 46 may be configured to engage in regenerative braking from the start of a descending application. In embodiments where the hoist 20 is configured to automatically engage in regenerative braking during a descent (e.g., the hoist is configured to always use regenerative braking during descent), the hoist 20 is unable to descend if the SOC of battery 46 is at 100%, or the hoist 20 is able to descend partway before being unable to descend any further (e.g., the SOC of the battery starts at 98% and reaches 100% during the descent). Accordingly, an advantage of charging the battery 46 to a specific threshold less than 100% SOC (e.g., 90%, 95%) is that such hoists 20 that require regenerative braking can descent an entire span of a descent without restriction.

The battery management system 45 transmits battery 46 temperature data to the controller 60. The controller 60 may store a battery temperature threshold on the memory 66, which may define an acceptable temperature range for the battery 46. In some examples, the battery temperature threshold includes a minimum threshold of 0° C. and a maximum threshold of 40° C. If the battery management system 45 transmits a battery temperature that exceeds the battery temperature threshold, then the controller 60 may route power generated by the motor 26 to the electric device 72 rather than routing the power to the battery 46 for charging. In other examples, the controller 60 does not include the processor 64 or the memory 66. In such examples, the controller 60 is programmed to receive a battery temperature, and route the power generated by the motor 26 to the electric device 72 responsive to the battery 46 exceeding a predetermined temperature threshold. Advantageously, the controller 60 helps to prevent overheating the battery 46 by routing power to the electric device 72 when the battery temperature is not within the acceptable range.

In some examples, the motor 26 is coupled with one or more real or virtual temperature sensors (e.g., sensors 27). In this way, the temperature of the motor 26 may be used as a stand in for the battery 46 temperature data. The controller 60 may store a motor temperature threshold on the memory 66, which may define an acceptable temperature range for the motor 26. If the temperature sensors transmit a motor temperature that exceeds the motor temperature threshold, then the controller 60 may route power generated by the motor 26 to the electric device 72 rather than routing the power to the battery 46 for charging. In some examples the temperature of the motor 26 is used by the controller 60 as an input in an algorithm, model, lookup table, etc. to determine or estimate a battery temperature.

In some examples the battery management system 45 includes or may be connected to one or more secondary batteries. The secondary batteries may be connected to the battery 46 in parallel or in series. As discussed above, the battery 46 powers the motor 26 through the controller 60. In example applications where larger motors 26 or high speeds are needed, a user may add additional batteries to the system 600. For example, to raise and lower the swing stage 100 shown in FIG. 1, one battery 46 per hoist 20 is provided. As another example, to raise and lower the elevator car 22 shown in FIG. 3, three batteries may be used to power each hoist 20. However, it will be appreciated that any number of batteries may be used for any application described herein.

Referring to FIG. 8, a block diagram of a control system 800 including the hoist 20 is shown, according to exemplary embodiments. The control system 800 is shown to include the battery 46, the hoist 20, the controller 60, the indicator device 84, and an accelerometer 86.

In the example shown in FIG. 8, the controller 60 includes one or more specialized processing circuits, shown as load measurement circuit 80 and stall detection circuit 82. In one configuration, the load measurement circuit 80 and the stall detection circuit 82 are embodied as machine-or computer-readable media storing instructions that are executable by a processor, such as processor 64. As described herein and amongst other uses, the machine-readable media facilitates performance of certain operations to enable reception and transmission of data. For example, the machine-readable media may provide an instruction (e.g., command, etc.) to acquire data. In this regard, the machine-readable media may include programmable logic that defines the frequency of acquisition of the data (or, transmission of the data). The computer-readable media instructions may include code, which may be written in any programming language including, but not limited to, Java or the like, and any conventional procedural programming languages, such as the “C” programming language or similar programming languages. The computer-readable program code may be executed on one processor or multiple remote processors. In the latter scenario, the remote processors may be connected to each other through any type of network (e.g., CAN bus, etc.).

In another configuration, the load measurement circuit 80 and the stall detection circuit 82 are embodied as one or more hardware units, such as one or more electronic control units. As such, the load measurement circuit 80 and the stall detection circuit 82 may be embodied as one or more circuitry components including, but not limited to, processing circuitry, network interfaces, peripheral devices, input devices, output devices, sensors, etc. In some embodiments, the load measurement circuit 80 and the stall detection circuit 82 may take the form of one or more analog circuits, electronic circuits (e.g., integrated circuits (IC), discrete circuits, system on a chip (SOCs) circuits, microcontrollers, etc.), telecommunication circuits, hybrid circuits, and any other type of “circuit. ” In this regard, the load measurement circuit 80 and the stall detection circuit 82 may include any type of component for accomplishing or facilitating achievement of the operations described herein. For example, a circuit, as described herein, may include one or more transistors, logic gates (e.g., NAND, AND, NOR, OR, XOR, NOT, XNOR, etc.), resistors, multiplexers, registers, capacitors, inductors, diodes, wiring, and so on. The load measurement circuit 80 and the stall detection circuit 82 may also include or be programmable hardware devices, such as field programmable gate arrays, programmable array logic, programmable logic devices or the like. The load measurement circuit 80 and the stall detection circuit 82 may include one or more memory devices for storing instructions that are executable by the processor(s) of the load measurement circuit 80 and the stall detection circuit 82. The one or more memory devices and processor(s) may have the same definition, as provided below, with respect to the memory device 66 and processor 64. In some hardware unit configurations, the load measurement circuit 80 and the stall detection circuit 82 may be geographically dispersed throughout separate locations in the vehicle. Alternatively, and as shown, the load measurement circuit 80 and the stall detection circuit 82 may be embodied in or within a single unit/housing, which is shown as the controller 60.

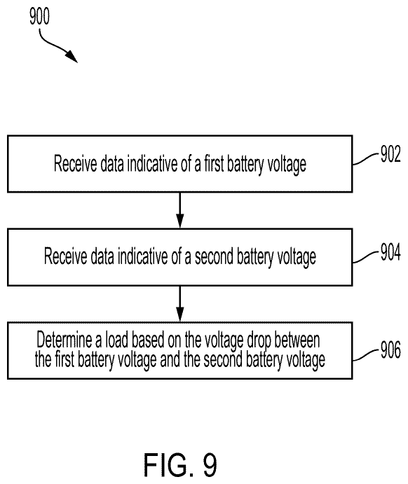

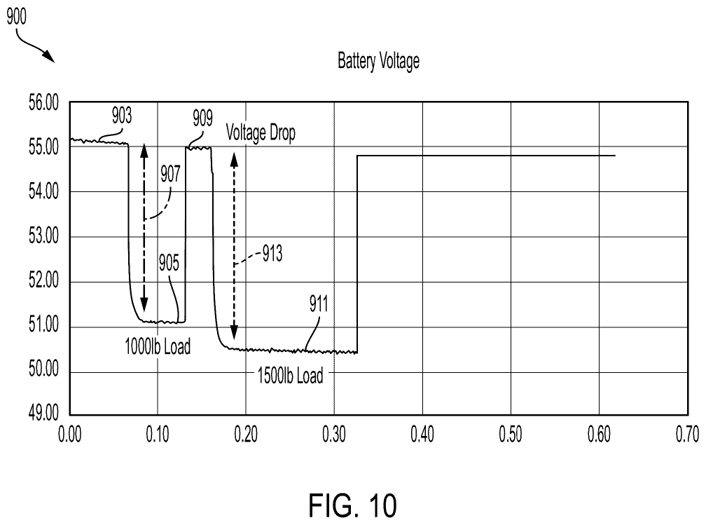

The battery 46 provides electrical power to the controller 60. Accordingly, the controller 60 receives voltage from the battery 46 to power on. The controller 60, or more specifically, the load measurement circuit 80, is structured to receive an analog voltage signal from the battery 46 and convert it into a digital signal (e.g., by one or more integrated analog input pins, etc.). The analog voltage signal from the battery 46 is a continuous electrical signal where the voltage level varies over time to represent changing battery conditions. For example, and as will be described in greater detail with respect to FIGS. 9-10, the load measurement circuit 80 may detect voltage drops within the battery 46. The voltage drop refers to a reduction in electrical potential (e.g., voltage) that occurs due to the current demand on the battery 46. By monitoring the battery 46 voltage directly, the load measurement circuit 80 can estimate changes in applied load on the battery 46 independently of voltage sensors or battery management systems.

Additionally or alternatively, the load measurement circuit 80 may be structured or configured to receive data indicative of a battery voltage from a battery management system (e.g., the battery management system 45 shown in FIG. 7). For example, the battery management system 45 may include sensors 48 structured as voltage sensors. The load measurement circuit 80 may receive the data indicative of the battery voltage from the sensors 48 and may determine changes in voltage of the battery 46 over time.

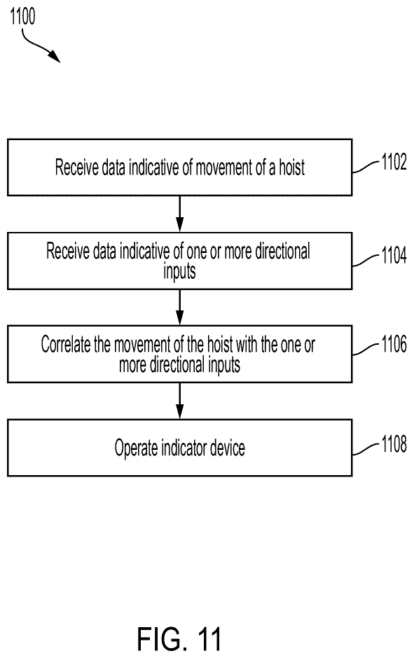

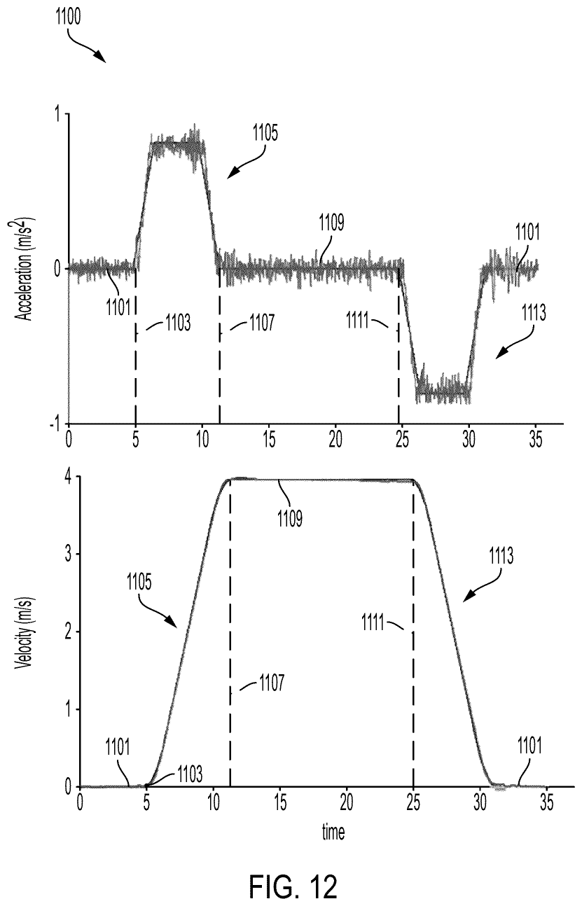

The stall detection circuit 82 is structured or configured to operate the indicator device 84 based on data indicative of movement of the hoist 20 received from the accelerometer 86 and directional commands input via the directional controls 29. The accelerometer 86 is structured to measure an acceleration of the hoist 20 and quantify the change in direction of the hoist 20 during acceleration. The accelerometer 86 may detect physical movement of the hoist 20 in any given direction. As described above, the directional controls 29 are configured to send a signal to the hoist 20 to move the elevator car 22 in a direction that corresponds to the input from the user. As will be described in greater detail with respect to FIGS. 11-12, the stall detection circuit 82 may correlate the data received from the accelerometer 86 to the direction inputs received from the directional controls 29. For example, if the stall detection circuit 82 receives an upward command from the directional controls 29 and the data from the accelerator indicates an acceleration that is less than a predefined threshold, then the stall detection circuit 82 may operate the indicator device 84 to activate (e.g., by turning on a light, causing a light to flash, activating an audial alarm, etc.).

Referring to FIGS. 9 and 10, a flow diagram and a graphical diagram of a process 900 for determining hoist 20 load based on voltage drop across the battery 46 is shown, according to exemplary embodiments. In some embodiments, the process 900 is performed by the controller 60, or more specifically, by the load measurement circuit 80.

At process 902, the load measurement circuit 80 receives data indicative of a first voltage of the battery 46. As noted above, the load measurement circuit 80 may receive voltage data from the battery 46 directly (e.g., as an analog signal), from one or more sensors 48, and/or from a BMS 45. In some examples, the sensors 48 detect the first voltage of the battery 46 by detecting a difference in electric potential between a positive terminal of the battery 46 and a negative terminal of the battery 46. The first battery voltage is exemplified by line 903 on the graph of FIG. 10. As can be seen on the graph of FIG. 10, the first voltage of the battery 46 may be the same as or relatively similar to (e.g., within 1V of) the voltage rating of the battery 46. By way of example, the battery 46 may be a 55V battery (e.g., a battery having a 55V rating or 55V nominal voltage). In this way, the first battery voltage may be 55V±1V.

At process 904, the load measurement circuit 80 receives data indicative of a second voltage of the battery 46. In some examples, the load measurement circuit 80 receives data indicative of the voltage of the battery 46 continuously, nearly continuously, or in predefined intervals of time (e.g., every second, every minute, etc.). The second voltage of the battery 46, for example, may be measured after a load is applied to the hoist 20. For example, by operating the hoist 20 to lift any of the apparatuses shown in FIGS. 1-3, the second battery voltage is exemplified by line 905 on the graph of FIG. 10.

At process 906, the load measurement circuit 80 determines a load based on the difference between the first battery voltage and the second battery voltage. The difference between the first battery voltage and the second battery voltage represents the voltage drop across the battery 46 when a load is applied to the battery 46. The load measurement circuit 80 may correlate the voltage drop to a load, for example, by applying a lookup table, a model, an algorithm, or the like. The load may be output as a load on the hoist 20 in terms of weight. Additionally or alternatively, the load may be measured as a load on the battery 46 in terms of the current drawn from the battery 46 by the hoist 20 in operation. In some examples, the current drawn from the battery 46 by the hoist 20 in operation is calculated as a part of the process of correlating the voltage drop to a load in terms of force. By way of example, the load measurement circuit 80 may correlate the first voltage drop 907 to a first load weight carried by the hoist 20 in operation. As shown in FIG. 10, the first load weight may be 1000 pounds of force carried by the hoist 20.

The load measurement circuit 80 may continue to determine loads based on voltage drops across the battery 46 throughout operation. In this way, the load measurement circuit 80 may detect when loads change (e.g., due to an operator entering or exiting the swing stage 100, the mast climber 200, the elevator car 22, etc., due to an operator adding or removing equipment from the swing stage 100, the mast climber 200, the elevator car 22, etc.). For example, as shown in FIG. 10, the difference between a third voltage of the battery 46, exemplified by line 909, and a fourth voltage of the battery 46, exemplified by the line 913 represents a second voltage drop 911 across the battery 46. In some examples, the third voltage of the battery 46 is less than the first voltage of the battery 46 due to a partial discharge of the battery 46 while providing power to the hoist 20 under the first load weight. The difference between the third voltage (e.g., as exemplified by line 909) of the battery 46 and the fourth voltage of the battery 46 is shown to be greater than the difference between the first voltage (e.g., as exemplified by line 903) and the second voltage (e.g., as exemplified by line 905). In this way, the second voltage drop 911 is greater than the first voltage drop 907, indicating that the load on the hoist 20 is carrying a greater load than the first load weight, and therefore, is drawing a higher current from the battery 46 than the first load weight. Accordingly, the load measurement circuit 80 may correlate the second voltage drop 911 to a second load weight carried by the hoist 20 in operation. As shown in FIG. 10, the second load weight may be 1500 pounds of force carried by the hoist 20.

Referring now to FIGS. 11 and 12, a flow diagram and a graphical diagram of a process 1100 for operating the indicator device 84 based on data from the accelerometer 86 and direction inputs from the directional controls 29, according to exemplary embodiments. In some embodiments, the process 1100 is performed by the controller 60, or more specifically, by the stall detection circuit 82.

At process 1102, the stall detection circuit 82 receives data indicative of movement of the hoist 20 from the accelerometer 86. More specifically, the stall detection circuit 82 receives data indicative of an acceleration and an associated direction of travel of the hoist 20 from the accelerometer 86. For example, the accelerometer 86 may transmit data indicating that the hoist 20 is traveling upward at particular number of feet per minute. As another example, the accelerometer may transmit data indicating that the hoist 20 is traveling downward at a particular number of feet per minute. In some examples, the stall detection circuit 82 receives a predefined threshold associated with the acceleration of the hoist 20. If the data indicative of the movement of the hoist 20 transmitted to the stall detection circuit 82 by the accelerometer 86 is less than the predefined threshold, then the stall detection circuit 82 may determine that the hoist 20 is not moving. For example, if the data indicative of the movement of the hoist 20 includes an acceleration of 0.1 feet per minute or less, then the stall detection circuit 82 may determine that the hoist 20 is not moving (e.g., operating in a stationary condition).

At process 1104, the stall detection circuit 82 receives data indicative of one or more inputs made by an operator via the directional controls 29. Such inputs may be, for example, an operator input via the directional controls 29 to move the hoist 20 downwards or upwards.

At process 1106, the stall detection circuit 82 correlates the hoist 20 movement and acceleration data transmitted by the accelerometer 86. For example, if the stall detection circuit 82 receives data indicating that an operator has input an upward command via the directional controls 29, the stall detection circuit 82 may confirm that the upward command was applied by the hoist 20 based on the movement and acceleration data transmitted by the accelerometer. For example, if the stall detection circuit 82 receives data indicating that an operator has input an upward command via the directional controls 29 and the accelerometer 86 transmits data indicating that the hoist 20 accelerated upward (e.g., relative to an initial/former position) at a particular number of feet per minute, then the stall detection circuit 82 may determine that the hoist 20 is operating as intended. However, if the stall detection circuit 82 receives data indicating that an operator has input an upward command via the directional controls 29 and the accelerometer 86 transmits data indicating that the hoist 20 is stationary (e.g., the data indicative of the movement of the hoist 20 is less than the predefined threshold) or moving in a downward direction at a particular number of feet per minute, then the stall detection circuit 82 may determine that the hoist 20 is not operating as intended. For example, if the stall detection circuit 82 receives data indicating that an operator has input an upward command via the directional controls 29 and the accelerometer 86 transmits data indicating that the hoist 20 is stationary, the stall detection circuit 82 may determine that the hoist 20 is stalled. When the hoist 20 is stalled, the motor 26 within the hoist fails to rotate despite receiving electrical power from the battery 46.

At optional process 1108, the stall detection circuit 82 operates the indicator device 84 based on the correlation of the hoist 20 movement and the acceleration data transmitted by the accelerometer 86. For example, if the stall detection circuit 82 receives data indicating that an operator has input an upward command via the directional controls 29, the stall detection circuit 82 may not activate the indicator device 84. In some examples, if the stall detection circuit 82 receives data indicating that an operator has input an upward command via the directional controls 29, the stall detection circuit 82 activates the indicator device to display or indicate a normal operating condition (e.g., by displaying a green light, by displaying text indicating a normal operating condition, by outputting a predefined first sound, etc.). If the stall detection circuit 82 receives data indicating that an operator has input an upward command via the directional controls 29 and the accelerometer 86 transmits data indicating that the hoist 20 is stationary, the stall detection circuit 82 may operate the indicator device 84 to display or indicate a stall condition (e.g., by displaying a red light, by displaying text indicating a stall condition, by outputting a predefined second sound, etc.).

FIG. 12 shows a graphical example of data indicative of the acceleration of the hoist 20 as the hoist 20 moves transmitted to the stall detection circuit 82 by the accelerometer 86. Based on the acceleration data, the accelerometer 86 and/or the stall detection circuit 82 may determine the changes in velocity over time. As shown in FIG. 12, the hoist 20 begins in a stationary state, as exemplified by line 1101. As shown by line 1101 in the stationary state, the hoist 20 does not accelerate, and therefore, does not experience a change in velocity over time. At point 1103 (e.g., approximately time=5 seconds), the hoist 20 begins to accelerate, such that the velocity of the hoist 20 increases over time. This acceleration is exemplified by line 1105 on the graphs. At point 1107 (e.g., approximately time=12 seconds), the hoist 20 stops accelerating, such that the velocity of the hoist remains relatively constant over time (e.g., as exemplified by line 1109). At point 1111 (e.g., approximately time=25 seconds), the hoist 20 begins to decelerate, thereby slowing the velocity of the hoist 20 over time (e.g., as exemplified by line 1113) until the hoist 20 returns to the stationary state as exemplified by line 1101. In this example, if an operator input an upward directional command via the directional controls 29 at point 1103 (e.g., approximately time=5 seconds), the data from the accelerometer 86 confirms that the hoist 20 did respond by moving upward. In this way, the stall detection circuit 82 may not activate the indicator device 84. Alternatively, the stall detection circuit may activate the indicator device 84 to display or indicate a normal operating condition.

If the stall detection circuit 82 received an upward directional command from the directional controls 29, but the hoist 20 remained in the stationary state (e.g., as exemplified by line 1101) for more than a predefined time threshold (e.g., for more than 1-5 seconds, etc.), then stall detection circuit may activate the indicator device 84 to display or indicate a stall condition.

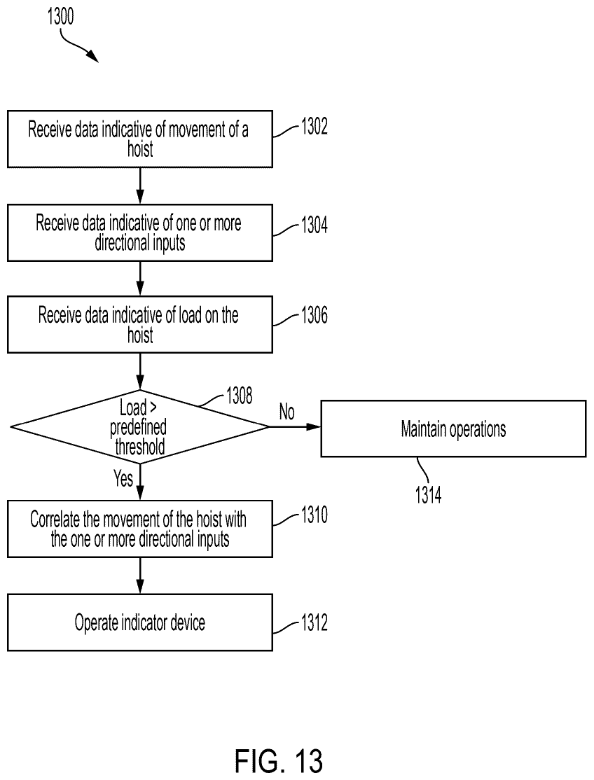

Referring to FIG. 13, a flow diagram of a process 1300 for operating the indicator device 84 based on data from the accelerometer 86, direction inputs from the directional controls 29, and load data from the load detection circuit 80 according to exemplary embodiments. The process 1300 may include at least some of the process 900 and the process 1100. In some embodiments, the process 1300 is performed by the controller 60, or more specifically, by the stall detection circuit 82.

At process 1302, the stall detection circuit 82 receives data indicative of movement of the hoist 20 from the accelerometer 86. The process 1302 may be the same as, or substantially similar to, the process 1102 described above.

At process 1304, the stall detection circuit 82 receives data indicative of one or more inputs made by an operator via the directional controls 29 (e.g., a command to move the hoist upwards or downwards). The process 1304 may be the same as, or substantially similar to, the process 1104 described above.

At process 1306, the stall detection circuit 82 receives data indicative of the load on the hoist 20 from the load measurement circuit 80. The load measurement circuit 80 may perform the process 900, as described above, to determine a load on the hoist. The load may be, for example, a weight to be lifted/lowered by the hoist 20.

At process 1308, the stall detection circuit 82 compares the load on the hoist 20 to a predefined threshold load. In some examples, the predefined threshold load is zero or nearly zero (e.g., 0-10 pounds etc.).

If the load on the hoist 20 is less than or equal to the predefined threshold load, the stall detection circuit 82 proceeds to process 1314. If the load on the hoist 20 is equal to or less than the predefined threshold, then the stall detection circuit 82 may determine that a stall condition is not applicable. Accordingly, the stall detection circuit 82 may maintain operation of the hoist 20, without operating/activating the indicator device 84. For example, if an operator is testing the hoist 20 while the hoist 20 rests on a surface and is disconnected from the cable 24, the stall detection circuit 82 may receive directional commands via the directional controls 29 and data from the accelerometer 86 indicating that the hoist 20 is not moving. In such a situation, the stall detection circuit 82 may opt not to operate the indicator device 86 to display or indicate a stall condition.

If the load on the hoist 20 is greater than the predefined threshold load, the stall detection circuit 82 proceeds to process 1310. At process 1310, the stall detection circuit 82 correlates the data indicative of movement of the hoist 20 received from the accelerometer 86 and the one or more directional inputs received from the directional controls 29. The process 1310 may be the same as, or substantially similar to, the process 1106 described above. Based on the correlation between the one or more directional inputs and the movement of the hoist 20, the stall detection circuit 82 may operate the indicator device (e.g., process 1312). The process 1312 may be the same as, or substantially similar to, the process 1108 described above.

Having now described some illustrative implementations, it is apparent that the foregoing is illustrative and not limiting, having been presented by way of example. In particular, although many of the examples presented herein involve specific combinations of method acts or system elements, those acts, and those elements may be combined in other ways to accomplish the same objectives. Acts, elements, and features discussed in connection with one implementation are not intended to be excluded from a similar role in other implementations.

The phraseology and terminology used herein is for the purpose of description and should not be regarded as limiting. The use of “including,” “comprising,” “having,” “containing,” “involving,” “characterized by,” “characterized in that,” and variations thereof herein is meant to encompass the items listed thereafter, equivalents thereof, and additional items, as well as alternate implementations consisting of the items listed thereafter exclusively. In one implementation, the systems and methods described herein consist of one, each combination of more than one, or all of the described elements, acts, or components.

Any references to implementations or elements or acts of the systems and methods herein referred to in the singular may also embrace implementations including a plurality of these elements, and any references in plural to any implementation or element or act herein may also embrace implementations including only a single element. References in the singular or plural form are not intended to limit the presently disclosed systems or methods, their components, acts, or elements to single or plural configurations. References to any act or element being based on any information, act or element may include implementations where the act or element is based at least in part on any information, act, or element.

Any implementation disclosed herein may be combined with any other implementation or embodiment, and references to “an implementation,” “some implementations,” “one implementation,” or the like are not necessarily mutually exclusive and are intended to indicate that a particular feature, structure, or characteristic described in connection with the implementation may be included in at least one implementation or embodiment. Such terms as used herein are not necessarily all referring to the same implementation. Any implementation may be combined with any other implementation, inclusively or exclusively, in any manner consistent with the aspects and implementations disclosed herein.

References to “or” may be construed as inclusive so that any terms described using “or” may indicate any of a single, more than one, and all of the described terms. References to, at least one of, a conjunctive list of terms may be construed as an inclusive “or” to indicate any of a single, more than one, and all of the described terms. For example, a reference to “at least one of ‘A’ and ‘B’” can include only ‘A,’ only ‘B,’ as well as both ‘A’ and ‘B.’ Such references used in conjunction with “comprising”or other open terminology can include additional items.

Where technical features in the drawings, detailed description or any claim are followed by reference signs, the reference signs have been included to increase the intelligibility of the drawings, detailed description, and claims. Accordingly, neither the reference signs nor their absence has any limiting effect on the scope of any claim elements.

Modifications of described elements and acts such as variations in sizes, dimensions, structures, shapes and proportions of the various elements, values of parameters, mounting arrangements, use of materials, colors, or orientations can occur without materially departing from the teachings and advantages of the subject matter disclosed herein. For example, elements shown as integrally formed can be constructed of multiple parts or elements, the position of elements can be reversed or otherwise varied, and the nature or number of discrete elements or positions can be altered or varied. Other substitutions, modifications, changes, and omissions can also be made in the design, operating conditions, and arrangement of the disclosed elements and operations without departing from the scope of the present disclosure.

For example, descriptions of top and bottom, upper and lower, front and back, or left and right may be reversed or interchangeable. Elements described as negative elements can instead be configured as positive elements and elements described as positive elements can instead by configured as negative elements. For example, elements described as having first polarity can instead have a second polarity, and elements described as having a second polarity can instead have a first polarity. Further relative parallel, perpendicular, vertical or other positioning or orientation descriptions include variations within +/−10% or +/−10 degrees of pure vertical, parallel or perpendicular positioning. References to “approximately,” “substantially,” or other terms of degree include variations of +/−10% from the given measurement, unit, or range unless explicitly indicated otherwise. Coupled elements can be electrically, mechanically, or physically coupled with one another directly or with intervening elements. Scope of the systems and methods described herein is thus indicated by the appended claims, rather than the foregoing description, and changes that come within the meaning and range of equivalency of the claims are embraced therein.

As mentioned above and in one configuration, the “circuits” may be implemented in machine-readable medium storing instructions (e.g., embodied as executable code) for execution by various types of processors, such as the processor 64 of FIGS. 7 and 8. Executable code may, for instance, comprise one or more physical or logical blocks of computer instructions, which may, for instance, be organized as an object, procedure, or function. Nevertheless, the executables need not be physically located together but may comprise disparate instructions stored in different locations which, when joined logically together, comprise the circuit and achieve the stated purpose for the circuit. Indeed, a circuit of computer readable program code may be a single instruction, or many instructions, and may even be distributed over several different code segments, among different programs, and across several memory devices. Similarly, operational data may be identified and illustrated herein within circuits and may be embodied in any suitable form and organized within any suitable type of data structure. The operational data may be collected as a single data set or may be distributed over different locations including over different storage devices, and may exist, at least partially, merely as electronic signals on a system or network.

While the term “processor” is briefly defined above, the term “processor” and “processing circuit” are meant to be broadly interpreted. In this regard and as mentioned above, the “processor” may be implemented as one or more processors, application specific integrated circuits (ASICs), field programmable gate arrays (FPGAs), digital signal processors (DSPs), or other suitable electronic data processing components structured to execute instructions provided by memory. The one or more processors may take the form of a single core processor, multi-core processor (e.g., a dual core processor, triple core processor, quad core processor, etc.), microprocessor, etc. In some embodiments, the one or more processors may be external to the apparatus, for example the one or more processors may be a remote processor (e.g., a cloud-based processor). Alternatively or additionally, the one or more processors may be internal and/or local to the apparatus. In this regard, a given circuit or components thereof may be disposed locally (e.g., as part of a local server, a local computing system, etc.) or remotely (e.g., as part of a remote server such as a cloud-based server). To that end, a “circuit” as described herein may include components that are distributed across one or more locations.

Embodiments within the scope of the present disclosure include program products comprising computer or machine-readable media for carrying or having computer or machine-executable instructions or data structures stored thereon. Such machine-readable media can be any available media that can be accessed by a computer. The computer readable medium may be a tangible computer readable storage medium storing the computer readable program code. The computer readable storage medium may be, for example, but not limited to, an electronic, magnetic, optical, electromagnetic, infrared, holographic, micromechanical, or semiconductor system, apparatus, or device, or any suitable combination of the foregoing. More specific examples of the computer readable medium may include, but are not limited to, a portable computer diskette, a hard disk, a random access memory (RAM), a read-only memory (ROM), an erasable programmable read-only memory (EPROM or Flash memory), a portable compact disc read-only memory (CD-ROM), a digital versatile disc (DVD), an optical storage device, a magnetic storage device, a holographic storage medium, a micromechanical storage device, or any suitable combination of the foregoing. In the context of this document, a computer readable storage medium may be any tangible medium that can contain, and/or store computer readable program code for use by and/or in connection with an instruction execution system, apparatus, or device. Machine-executable instructions include, for example, instructions and data which cause a computer or processing machine to perform a certain function or group of functions.

The computer readable medium may also be a computer readable signal medium. A computer readable signal medium may include a propagated data signal with computer readable program code embodied therein, for example, in baseband or as part of a carrier wave. Such a propagated signal may take any of a variety of forms, including, but not limited to, electrical, electro-magnetic, magnetic, optical, or any suitable combination thereof. A computer readable signal medium may be any computer readable medium that is not a computer readable storage medium and that can communicate, propagate, or transport computer readable program code for use by or in connection with an instruction execution system, apparatus, or device. Computer readable program code embodied on a computer readable signal medium may be transmitted using any appropriate medium, including but not limited to wireless, wireline, optical fiber cable, Radio Frequency (RF), or the like, or any suitable combination of the foregoing medium.

In one embodiment, the computer readable medium may comprise a combination of one or more computer readable storage mediums and one or more computer readable signal mediums. For example, computer readable program code may be both propagated as an electro-magnetic signal through a fiber optic cable for execution by a processor and stored on RAM storage device for execution by the processor.

Computer readable program code for carrying out operations for aspects of the present disclosure may be written in any combination of one or more other programming languages, including an object oriented programming language such as Java, Smalltalk, C++ or the like and conventional procedural programming languages, such as the “C” programming language or similar programming languages. The computer readable program code may execute entirely on the user's computer, partly on the user's computer, as a stand-alone computer-readable package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

The program code may also be stored in a computer readable medium that can direct a computer, other programmable data processing apparatus, or other devices to function in a particular manner, such that the instructions stored in the computer readable medium produce an article of manufacture including instructions which implement the function/act specified in the schematic flowchart diagrams and/or schematic block diagrams block or blocks.

Although the figures and description may illustrate a specific order of method steps, the order of such steps may differ from what is depicted and described, unless specified differently above. Also, two or more steps may be performed concurrently or with partial concurrence, unless specified differently above. Such variation may depend, for example, on the software and hardware systems chosen and on designer choice. All such variations are within the scope of the disclosure. Likewise, software implementations of the described methods could be accomplished with standard programming techniques with rule-based logic and other logic to accomplish the various connection steps, processing steps, comparison steps, and decision steps.

It is important to note that the construction and arrangement of the apparatus and system as shown in the various exemplary embodiments is illustrative only. Additionally, any element disclosed in one embodiment may be incorporated or utilized with any other embodiment disclosed herein.

What is claimed is:

1. A system comprising:
a battery; and
a hoist comprising:
a motor configured to move the hoist relative to a cable and to provide power generated by moving the hoist to the battery; and
a controller configured to:
receive data indicative of a load on the hoist; and
operate the motor to stop movement of the hoist relative to the cable based on the load on the hoist exceeding a predefined threshold.

2. The system of claim 1, further comprising an electric device, wherein the controller is further configured to:
receive data indicative of a temperature of the battery; and
redirect the power generated by the motor to the electric device, rather than to the battery, based on the temperature of the battery exceeding a threshold temperature.

3. The system of claim 2, wherein the electric device includes at least one of a resistor or a capacitor.

4. The system of claim 1, further comprising an electric device, wherein the controller is configured to:
receive data indicative of a state of charge of the battery; and
redirect the power generated by the motor to the electric device, rather than to the battery, based on the state of charge of the battery exceeding a state of charge threshold.

5. The system of claim 1, wherein receiving the data indicative of a load on the hoist includes receiving data indicative of a first battery voltage associated with the battery and receiving data indicative of a second battery voltage associated with the battery, and wherein the controller is further configured to:
determine a voltage drop associated with the battery based on a difference between the first battery voltage and the second battery voltage; and
determine the load associated with the voltage drop.

6. The system of claim 5, further comprising an indicator device, wherein the controller is further configured to operate the indicator device based on the load associated with the voltage drop exceeding a predefined threshold.

7. The system of claim 1, further comprising an accelerometer configured to measure movement of the hoist, wherein the controller is further configured to:
receive, from the accelerometer, data indicative of the movement of the hoist;
receive data indicative of one or more directional input commands associated with the hoist;
correlate the movement of the hoist with the one or more directional input commands having an expected motion condition associated with the hoist; and
operate an indicator device based on the movement of the hoist failing to meet the expected motion condition associated with the hoist.

8. The system of claim 7, wherein the indicator device is a light and wherein operating the indicator device based on the movement of the hoist failing to meet the expected motion condition associated with the hoist comprises activating the light.

9. The system of claim 1, wherein the controller is further configured to:
receive, from the battery, a first power value; and
output, to the motor, a second power value based on the load on the hoist, the first power value different from the second power value.

10. The system of claim 1, wherein the controller is further configured to:
stop outputting power to the motor responsive to receiving data indicative of the load being over a threshold of a rated load for the hoist.

11. The system of claim 1, wherein the hoist further comprises a power output port configured to supply between 12V and 48V.

12. The system of claim 1, wherein the controller is further configured to:
receive an operating rule for the hoist, the operating rule comprising a maximum threshold for an operational parameter of the hoist; and
limit the operational parameter of the hoist based on the operating rule.

13. The system of claim 12, wherein the operating rule is at least one of (a) a maximum hoist speed or (b) a maximum hoist load weight.

14. A system comprising:
a hoist;
an accelerometer configured to measure movement of the hoist; and
a controller configured to:
receive, from the accelerometer, data indicative of movement of the hoist;
receive data indicative of one or more directional input commands associated with the hoist;
correlate the movement of the hoist with the one or more directional input commands having an expected motion condition associated with the hoist; and
operate an indicator device based on the movement of the hoist failing to meet the expected motion condition associated with the hoist.

15. The system of claim 14, wherein the indicator device is a light and wherein operating the indicator device based on the movement of the hoist failing to meet the expected motion condition associated with the hoist comprises activating the light.

16. The system of claim 14, further comprising a battery, wherein the controller is further configured to:
receive data indicative of a first battery voltage associated with the battery;
receive data indicative of a second battery voltage associated with the battery;
determine a voltage drop associated with the battery based on a difference between the first battery voltage and the second battery voltage; and
determine a load associated with the voltage drop.

17. The system of claim 16, wherein the controller is further configured to:
operate the indicator device based on the load associated with the voltage drop exceeding a predefined threshold and based on the movement of the hoist failing to meet the expected motion condition associated with the hoist.

18. A hoist comprising:
an accelerometer configured to measure movement of the hoist;
an indicator device configured to indicate one or more operating conditions of the hoist, the one or more operating conditions including a stall condition; and
a controller configured to:
receive, from the accelerometer, data indicative of movement of the hoist;
receive data indicative of one or more directional input commands associated with the hoist;
correlate the movement of the hoist with the one or more directional input commands having an expected motion condition associated with the hoist, wherein the hoist failing to meet the expected motion condition associated with the hoist corresponds to the stall condition; and
operate the indicator device based on the stall condition.

19. The hoist of claim 18, further comprising a battery, wherein the controller is further configured to:
receive data indicative of a first battery voltage associated with the battery;
receive data indicative of a second battery voltage associated with the battery;
determine a voltage drop associated with the battery based on a difference between the first battery voltage and the second battery voltage; and
determine a load associated with the voltage drop.

20. The hoist of claim 19, wherein the controller is further configured to:
operate the indicator device based on the load associated with the voltage drop exceeding a predefined threshold and based on the movement of the hoist failing to meet the expected motion condition associated with the hoist.
